(19) United States
(12) Patent Application Publication
(10) Pub. No.: US 2023/0256974 A1
(43) Pub. Date: Aug. 17, 2023

(54) STORAGE SYSTEM AND STORAGE CONTROL DEVICE

(71) Applicant: TOYOTA JIDOSHA KABUSHIKI KAISHA, Toyota-shi Aichi-ken (JP)

(72) Inventors: Takumi KOBAYASHI, Toyota-shi Aichi (JP); Yutaka TOKUNAGA, Toyota-shi Aichi (JP)

(73) Assignee: TOYOTA JIDOSHA KABUSHIKI KAISHA, Toyota-shi Aichi-ken (JP)

(21) Appl. No.: 18/107,240

(22) Filed: Feb. 8, 2023

(30) Foreign Application Priority Data
Feb. 17, 2022 (JP) 2022-022948

(51) Int. Cl. B60W 40/08; B60W 50/14

(52) U.S. Cl. CPC B60W 40/08; B60W 50/14; B60W 2555/20; B60W 2510/20; B60W 2510/18; B60W 2050/146

(57) ABSTRACT

A storage system for storing action information of an assistance system that assists a driver of a vehicle includes a storage device, a first acquisition unit acquiring action information from the assistance system, a second acquisition unit acquiring information related to a driving operation of the vehicle by the driver, a determination unit determining whether the driving operation is a first operation that suppresses assistance by the assistance system based on the action information and the information related to the driving operation, and a storage unit storing the action information and external information related to an ambient environment of the vehicle in association with each other in the storage device.

### CROSS-REFERENCE TO RELATED APPLICATION

This application is based on Japanese Patent Application No. 2022-022948 filed with Japan Patent Office on Feb. 17, 2022, the entire contents of which are hereby incorporated by reference.

### TECHNICAL FIELD

The present disclosure relates to a storage system and a storage control device.

### BACKGROUND ART

Japanese Patent Application Publication No. 2002-193070 discloses a storage system that stores vehicle information. This system includes a plurality of ECUs (Electronic Control Units). When an abnormality is detected by a self-diagnosis function of any ECU, a storage command for storing vehicle information is transmitted to the other ECU in which the abnormality is not detected through a communication line.

### SUMMARY

### Technical Problem

It is conceivable that an ECU (assistance ECU) that assists a driver of a vehicle is mounted on the system described in Japanese Patent Application Publication No. 2002-193070. In order to verify the action(operation) of the assistance ECU, action information of the assistance ECU and information related to the environment outside the vehicle at the assistance timing may be stored. The system described in Japanese Patent Application Publication No. 2002-193070 stores information when an abnormality is detected in any of a plurality of ECUs including the assistance ECU. For this reason, in the system described in Japanese Patent Application Publication No. 2002-193070, it is difficult to store information in a scene in which assistance unnecessary for the driver is executed although the assistance is normal as the system operation. The present disclosure provides a technique capable of appropriately storing information related to assist control.

### Solution to Problem

A storage system according to an aspect of the present disclosure stores action information of an assistance system that assists a driver of a vehicle. The storage system includes a storage device, a first acquisition unit, a second acquisition unit, a determination unit, and a storage unit. The first acquisition unit acquires action information from the assistance system. The second acquisition unit acquires information related to the driving operation of the vehicle of the driver. The determination unit determines whether the driving operation is a first operation that suppresses assistance by the assistance system based on the action information acquired by the first acquisition unit and the information related to the driving operation acquired by the second acquisition unit. In response to the determination unit determining that the driving operation is the first operation, the storage unit stores action information and external information related to the ambient environment of the vehicle in the storage device in association with each other.

In this storage system, action information is acquired from the assistance system, and information related to the driving operation of the vehicle of the driver is acquired. Then, it is determined whether or not the driving operation of the driver is a first operation that suppresses assistance by the assistance system. In response to determining that the driving operation is the first operation, action information and external information related to the ambient environment of the vehicle are stored in association with each other. The first operation is performed when assistance by the assistance system is unnecessary for the driver. Therefore, by storing information based on the first operation of the driver, the storage system can store information of a scene in which assistance that is normal as a system operation, however, is unnecessary for the driver is executed. Therefore, the storage system can appropriately store information related to the assistance control.

In one embodiment, the storage device may include a first storage device and a second storage device, the first storage device may temporarily store action information and external information in association with each other, the second storage device may acquire information from the first storage device and store the acquired information, and the storage unit may output an instruction to the second storage unit so as to acquire and store, in response to the first operation determination by the determination unit, the operation information and the external information stored in the first storage unit during a period from start timing to operation timing at which the first operation is executed, the start timing being time going back by a predetermined time from the operation timing. In this case, even when the reaction of the driving operation of the driver is delayed with respect to the assistance unnecessary for the driver, the storage system can store information of a scene in which the assistance unnecessary for the driver is executed.

In one embodiment, the first operation may be at least one driving operation among an operation of changing the irradiation position of the headlight set by the assistance system, a steering operation in the reverse direction during steering assistance by the assistance system, a brake operation during acceleration assistance by the assistance system, and an accelerator operation during deceleration assistance by the assistance system.

In one embodiment, the assistance system may provide assistance to notify the driver of the target speed, the determination unit may further determine whether the driving operation is a second operation in which the vehicle travels at a speed deviating from the target speed notified to the driver by a threshold value speed or more, and the storage unit may store the action information and the external information in the storage device in association with each other in response to the determination unit determining that the driving operation is the second operation. Like the first operation, the second operation is performed when the content of assistance by the assistance system is unnecessary for the driver. Therefore, by storing information based on the second operation of the driver, the storage system can store information of a scene in which assistance that is normal as a system operation, however, unnecessary for the driver is executed.

A storage control device according to another aspect of the present disclosure stores action information of an assistance system that assists a driver of a vehicle in a storage device. The storage control device includes a first acquisition unit, a second acquisition unit, a determination unit, and a storage unit. The first acquisition unit acquires action information from the assistance system. The second acquisition unit acquires information related to the driving operation of the vehicle of the driver. The determination unit determines whether the driving operation is a first operation that suppresses assistance by the assistance system based on the action information acquired by the first acquisition unit and the information related to the driving operation acquired by the second acquisition unit. In response to the determination unit determining that the driving operation is the first operation, the storage unit stores action information and external information related to the ambient environment of the vehicle in the storage device in association with each other. This storage control device has the same effect as the above-described storage system.

According to the present disclosure, there is provided a technique capable of appropriately storing information related to assist control.

### BRIEF DESCRIPTION OF DRAWINGS

FIG. 1 is a block diagram of a vehicle including a storage system according to one embodiment.

FIG. 2 is a flowchart showing an example of the operation of a storage system according to one embodiment.

FIG. 3 is a diagram illustrating information extracted from a buffer.

FIG. 4 is a flowchart showing another example of the operation of the storage system according to one embodiment.

### DESCRIPTION OF EMBODIMENTS

Hereinafter, embodiments of the present disclosure will be described with reference to the drawings. In the following description and drawings, the same or corresponding elements are denoted by the same reference signs, and redundant description will not be repeated.

(Configuration of Vehicle)

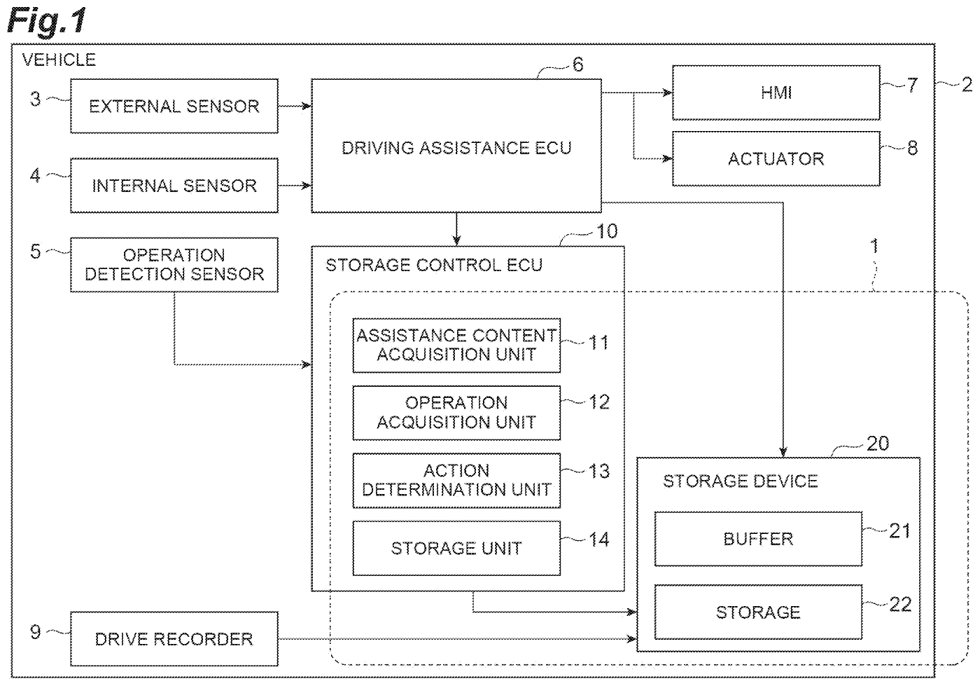

FIG. 1 is a block diagram of a vehicle including a storage system according to one embodiment. As shown in FIG. 1, a storage system 1 is mounted on a vehicle 2 as an example. The vehicle 2 mounts an assistance system that provides driving assistance to the driver. The content of driving assistance is not particularly limited. The driving assistance provided may be a so-called ADAS (Advanced Driver Assistance System). The ADAS may include follow-up driving assistance, inter-vehicle distance control assistance, anti-lock braking system (ABS), brake assistance, steering assistance, speed control assistance, display of external environment information, and the like. The storage system 1 stores the action information of the assistance system. The action information includes information capable of specifying assistance content. For example, the action information of the follow-up travel assistance is information such as a steering amount, a steering timing, an acceleration/deceleration amount, and an acceleration/deceleration timing given by the system. The storage system 1 can record information related to assistance felt unnecessary by the driver among the provided driving assistance by performing a function described later.

The vehicle 2 includes, for example, an external sensor 3, an internal sensor 4, an operation detection sensor 5, a driving assistance electronic control unit (ECU) 6, human machine interface (HMI) 7, an actuator 8, a drive recorder 9, a storage control ECU 10 (an example of a storage control device), and a storage device 20. The storage system 1 is configured with a storage control ECU 10 and the storage device 20.

The external sensor 3 is a detector that detects external information about the ambient environment of the vehicle 2. The ambient environment is a position of an object around the vehicle 2, a situation of the object, or the like. The external information includes the position, shape, color, and the like of an object in front of the roadway on which the vehicle 2 travels. Examples of the object include a vehicle, a pedestrian, a traffic light, and a road surface paint. The external sensor 3 may be a camera as an example, and the external information may be image information.

The camera is an imaging device that images the external situation of the vehicle 2. The camera is provided on the back side of the windshield of the vehicle 2 as an example. The camera acquires imaging information about an external situation of the vehicle 2. The camera may be a monocular camera, or may be a stereo camera. The stereo camera includes two imaging units arranged so as to reproduce a binocular parallax. The imaging information of stereo camera also includes information in the depth direction.

The external sensor 3 is not limited to a camera and may be a radar sensor or the like. The radar sensor is a detector that detects an object around the vehicle 2 using a radio wave (for example, a millimeter wave) or light. The radar sensor includes, for example, a millimeter wave radar or a laser imaging detection and ranging (LIDAR). The radar sensor detects an object by transmitting radio waves or light to the surroundings of the vehicle 2 and receiving radio waves or light reflected from the object.

The internal sensor 4 is a detector that detects the travel state of the vehicle 2. The internal sensor 4 may include at least one of a vehicle speed sensor, an acceleration sensor, and a yaw rate sensor. The vehicle speed sensor is a detector that detects the speed of the vehicle 2. As the vehicle speed sensor, for example, a wheel speed sensor that is provided on a wheel of the vehicle 2 or a drive shaft that rotates integrally with the wheel and detects the rotational speed of the wheel is used. The acceleration sensor is a detector that detects accelerations of the vehicle 2. The acceleration sensor may include a longitudinal acceleration sensor for detecting longitudinal accelerations of the vehicle 2 and a lateral acceleration sensor for detecting accelerations of the vehicle 2. The yaw rate sensor is a detector that detects a yaw rate (rotational angular velocity) of a vertical axis of the vehicle 2 of gravity. As the yaw rate sensor, for example, a gyro sensor can be used.

The operation detection sensor 5 is a detector that detects the driving operation of the vehicle 2 driver. The operation detection sensor 5 includes, for example, at least one of a steering angle sensor, a lever operation detection sensor, and a pedal sensor. The steering angle sensor is a detector that detects the rotation amount of the steering shaft of the vehicle 2. The lever operation detection sensor is a detector that detects an operation of an operation lever (direction indicator, direction (high beam) or low beam of a headlight, or the like) of the driver's seat. The pedal sensor is a detector that detects an operation amount of brake pedal, an operation amount of accelerator pedal, and the like.

The driving assistance ECU 6 functions as a driving assistance system to assist the vehicle 2 driver. The driving assistance ECU 6 includes a central processing unit (CPU), a read only memory (ROM), a random access memory (RAM), and a controller area network (CAN). The electronic control unit includes a communication circuit and the like. The driving assistance ECU 6 is connected to a network that communicates using, for example, a CAN communication circuit and is communicatively connected to the components of the vehicle 2 described above. For example, based on a signal output from the CPU, the driving assistance ECU 6 operates the CAN communication circuit to input and output data, stores the data in the RAM, loads a program stored in the ROM into the RAM, and executes the program loaded into the RAM, thereby implementing functions described below. The driving assistance ECU 6 may consist of a plurality of electronic control units.

HMI 7 is the interface between the vehicle 2 occupants (including drivers) and the system implemented by the driving assistance ECU6. The HMI 7 includes, for example, a touch display capable of displaying information and receiving an operation input of an occupant.

The actuator 8 is a device that executes running control of the vehicle 2. The actuator 8 includes at least engine actuators, brake actuators, and steering actuators. The engine actuators control the driving force of the vehicle 2 by changing an amount of air supplied to the engine (for example, changing a throttle opening degree) in accordance with a driving operation or a control signal from the driving assistance ECU 6. When the vehicle 2 is a hybrid electric vehicle or a battery electric vehicle, the engine actuators control the driving force of the motor as a power source.

The brake actuator controls the brake system in response to a control signal from the driving assistance ECU 6 and controls the braking force applied to the wheels of the vehicle 2. As the brake system, for example, a hydraulic brake system can be used. Note that the brake actuator may control both the hydraulic brake system and the regenerative brake system when the vehicle 2 is provided with the regenerative brake system. The steering actuator controls driving of an assist motor for controlling steering torque in an electric power steering system according to a control signal from the driving assistance ECU 6. Thus, the steering actuator controls the steering torque of the vehicle 2.

The drive recorder 9 is a device that records an image around the vehicle 2. The drive recorder 9 includes a camera that images the surroundings of the vehicle 2 and an internal storage device. That is, the drive recorder 9 is a device that acquires external information related to the ambient environment of the vehicle 2. Although the external sensor 3 and the drive recorder 9 are shown separately in FIG. 1 for simplicity of illustration, the drive recorder 9 may be included in the external sensor 3. The drive recorder 9 has a function of outputting an image to an external the storage device 20.

The storage control ECU 10 is a device that controls the storage device 20. Like the driving assistance ECU 6, the storage control ECU 10 is an electronic control unit including a CPU, a ROM, a RAM, a CAN communication circuit, and the like. The storage control ECU 10 is connected to the storage device 20 and determines the object of the information stored by the storage device 20 and stores it in the storage device 20. Alternatively, the storage control ECU 10 may cause the storage device 20 to determine and store information for the storage device 20 to store.

The storage device 20 is a device that stores information, and includes a ROM, a RAM, a hard disk drive (HDD), and the like. The storage device 20 is connected to the driving assistance ECU 6 and obtains action information from the driving assistance ECU 6. The storage device 20 is connected to the drive recorder 9 and obtains external information from the drive recorder 9. In the following description, an example of the external information is image information. In the storage device 20, action information and image information may be associated in time series. The storage device 20 stores action information and image information based on a control signal (an example of an instruction) output from the storage control ECU 10.

For example, the storage device 20 may start storing the action information and the image information in association with each other based on the reception timing of the storage start signal output from the storage control ECU 10. The storage device 20 may start storing action information and image information in association based on the timing indicated in the start trigger signal. The storage device 20 may end the storage operation after a predetermined period has elapsed from the reception timing of the storage start signal or the timing indicated by the start trigger signal. The storage device 20 may end the storage operation at the reception timing of the storage end signal or the timing indicated by the end trigger signal.

The storage device 20 may temporarily store the action information and the image information. The storage device 20 may copy a specified range of temporarily stored information from a temporary storage area to a non-temporary storage area on the basis of a control signal output from the storage control ECU 10. As a result, the storage device 20 can store information in a period prior to the timing at which the storage control ECU 10 control signal is received, that is, in the past. In order to realize such an operation, the storage device 20 includes a buffer 21 (an example of a first storage device) and a storage 22 (an example of a second storage device). The buffer 21 is a storage device that temporarily stores action information and image information. The temporary storage refers to storage in a form of being overwritten or erased when the capacity exceeds a threshold value or an event occurs. In general, the buffer 21 is configured to be overwritten from information at the beginning of the time series if the capacity exceeds a threshold value. As a result, the buffer 21 can continuously store time-series observation date for a certain period.

The storage 22 acquires and stores information from the buffer 21. The storage 22 acquires and stores the action information and the image information stored in the period instructed from the storage control ECU 10 among the action information and the image information stored in the buffer. The period instructed by the storage control ECU 10 may be a period from the reception timing of the storage start signal or the timing indicated by the start trigger signal to a timing that is a predetermined time backward. The predetermined time is a time arbitrarily set in advance.

The storage device 20 may temporarily store the action information and the image information, and inhibit overwriting or erasing of information in a specified range among the temporarily stored information based on a control signal output from the storage control ECU 10. In this case, the storage device 20 may include one of the buffer 21 and the storage 22.

In this manner, the storage control ECU 10 and the storage device 20 operate in cooperation with each other, so that the action information and the image information in the period specified by the storage control ECU 10 can be associated with each other and stored in the non-transitory area. The above-described processing can be realized not only by operating both the storage control ECU 10 and the control chip provided in the storage device 20 in cooperation with each other but also by controlling only the storage control ECU 10.

(Details of the Storage Control ECU)

The storage control ECU 10 functionally includes an assistance content acquisition unit 11 (an example of a first acquisition unit), an operation acquisition unit 12 (an example of a second acquisition unit), an action determination unit 13 (an example of a determination unit), and a storage unit 14.

The assistance content acquisition unit 11 acquires action information from the driving assistance ECU 6. As described above, the action information includes information capable of specifying the assistance content. The operation acquisition unit 12 acquires information related to the driving operation of the vehicle 2 of the driver. The operation acquisition unit 12 acquires information related to driving operation from the operation detection sensor 5.

Based on the action information acquired by the assistance content acquisition unit 11 and the information related to the driving operation acquired by the operation acquisition unit 12, the action determination unit 13 determines whether the driving operation is a first operation that suppresses assistance by the driving assistance ECU 6. The action determination unit 13 grasps assistance contents by action information of the driving assistance ECU 6, and grasps driving operation from information related to driving operation detected by the operation detection sensor 5. Then, the action determination unit 13 compares the assistance content with the driving operation to determine whether the driving operation is a first operation that suppresses the assistance. “Suppressing assistance” refers to a state in which driving operation is performed such that the effect of assistance is not exhibited or the effect of assistance is reduced.

For example, it is assumed that the assistance content acquisition unit 11 acquires action information indicating that the irradiation position of the headlight is set to the high beam by the driving assistance ECU 6 from the driving assistance ECU 6. Then, it is assumed that the operation detection sensor 5 detects information related to the driving operation in which the headlight set to the high beam is reset to the low beam. In this case, the action determination unit 13 determines that the driving operation that has been reset to low beam is a driving operation that does not exhibit the effect of the assistance of setting to the high beam, that is, a first operation.

For example, it is assumed that the assistance content acquisition unit 11 is provided with steering assistance by the driving assistance ECU 6 and acquires action information including a steering direction from the driving assistance ECU 6. Then, it is assumed that the operation detection sensor 5 detects information related to a steering operation in a direction opposite to the steering direction during the steering assist by the driving assistance ECU 6. In this case, the action determination unit 13 determines that the operation of changing the irradiation position of the headlight set by the driving assistance ECU 6 is the driving operation of preventing the effect of the steering assist by the driving assistance ECU 6 from being exerted, that is, the first operation.

For example, it is assumed that the assistance content acquisition unit 11 is provided with speed assist by the driving assistance ECU 6 and acquires action information including acceleration and deceleration from the driving assistance ECU 6. Then, it is assumed that the operation detection sensor 5 detects information related to a driving operation of stepping on a brake pedal during acceleration assist by the driving assistance ECU 6. In this case, the action determination unit 13 determines that the brake operation during the acceleration assist by the driving assistance ECU 6 is a driving operation in which the effect of the steering assist by the driving assistance ECU 6 is not exhibited, that is, the first operation. Similarly, it is assumed that the operation detection sensor 5 detects information related to a driving operation of stepping on the accelerator pedal during deceleration assist by the driving assistance ECU 6. In this case, the action determination unit 13 determines that the accelerator operation during the deceleration assist by the driving assistance ECU 6 is a driving operation in which the effect of the steering assist by the driving assistance ECU 6 is not exhibited, that is, the first operation.

In response to the action determination unit 13 determining that the driving operation is the first operation, the storage unit 14 stores action information and external information in association with each other in the storage device 20. This makes it possible to store action information and external information at the timing at which the first operation is performed.

(Operation of Storage System)

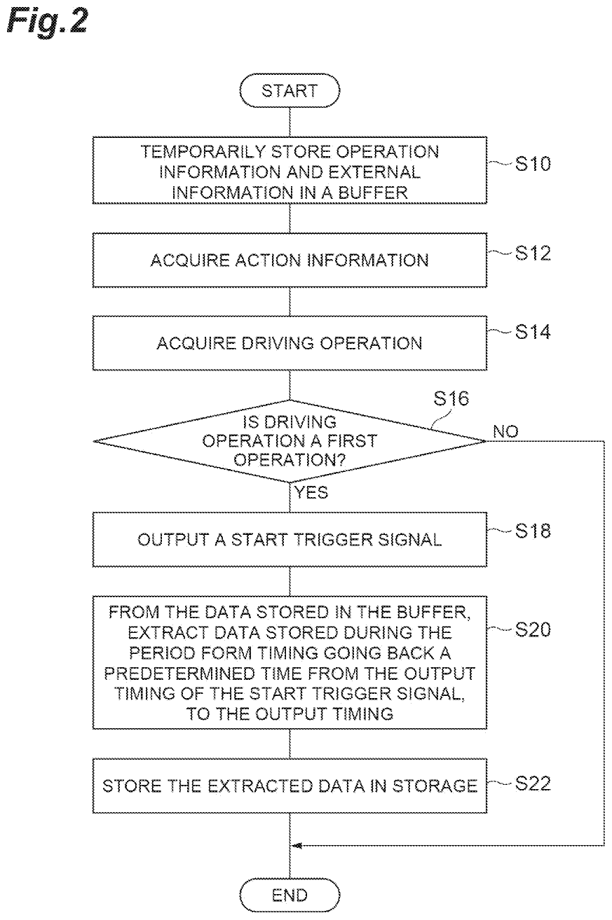

FIG. 2 is a flowchart illustrating an example of the operation of the storage system according to one embodiment. The flowchart shown in FIG. 2 is started at timing when the activation switch of the storage system 1, for example, is turned on by the operation of the occupant during the assistance of the driving assistance ECU 6.

As shown in FIG. 2, the storage device 20 included in the storage system 1 stores the driving assistance ECU 6 action information and the vehicle 2 external information (e.g., the drive recorder 9 image information) in the buffer 21 as a temporary storage processing (step S10). As a result, the buffer 21 stores action information and image information of a certain period in association with each other.

The assistance content acquisition unit 11 of the storage control ECU 10 acquires action information from the driving assistance ECU 6 as a first acquisition processing (step S12). Subsequently, the operation acquisition unit 12 of the storage control ECU 10 acquires information related to driving operation from the operation detection sensor 5 as a second acquisition processing (step S14).

The action determination unit 13 of the storage control ECU 10 determines whether the driving operation is the first operation based on the action information acquired in step S12 and the information related to the driving operation acquired in step S14 as a determination processing (step S16).

When it is determined that the driving operation is the first operation (step S16: YES), the storage unit 14 outputs a start trigger signal to the storage device 20 as an instruction processing (step S18). Subsequently, the storage device 20 extracts, as an extraction processing (step S20), from the date stored in the buffer 21, the date stored in the period from timing going back a predetermined time from the output timing of the start trigger signal, to the output timing.

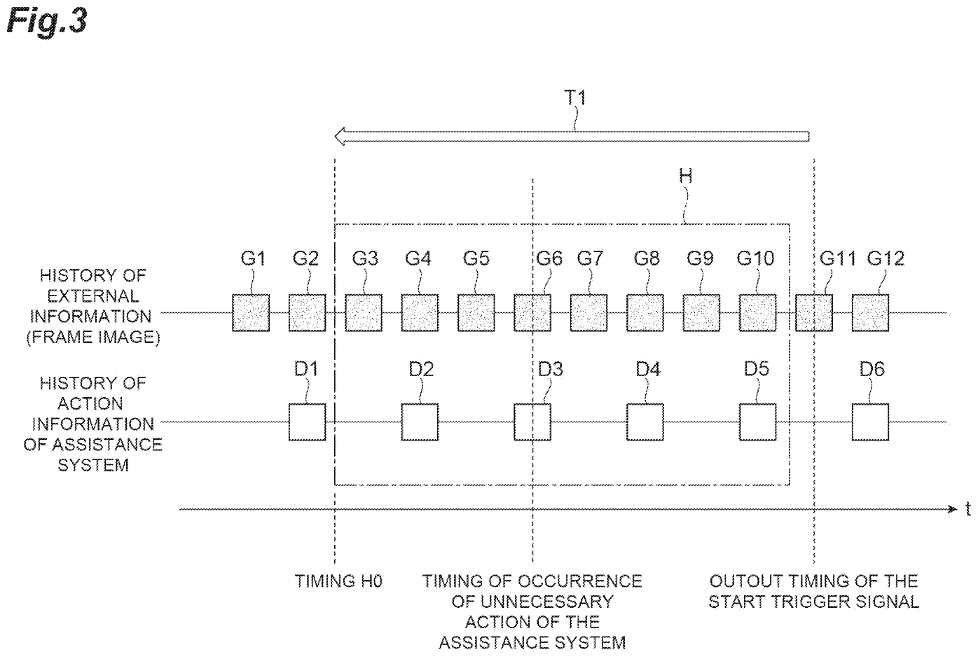

FIG. 3 is a diagram illustrating information extracted from the buffer. In FIG. 3, the information stored in the buffer 21 is shown time series as a history. As shown in FIG. 3, the horizontal axis is a time base t, and frame images G1-G12 of the drive recorder 9 are stored in the buffer 21 as external information in the imaging order. Action information D1-D6 of the driving assistance ECU 6 are stored in the buffer 21 in time series. Here, it is assumed that assistance which becomes unnecessary for the driver of the driving assistance ECU 6 is performed in a generation timing H1. In response to this, the first operation is performed by the driver, and the start trigger signal is output by the storage unit 14 (a output timing H2 (operation timing)). In this case, the storage device 20 stores a period H from timing H0 (start timing) to the output timing H2. The timing H0 is going back a predetermined time T1 from the output timing H2. Then, the storage device 20 extracts frame images G3-G10 contained in the period H and action information D2-D5 from the buffer 21.

Returning to FIG. 2, the storage device 20 stores the date extracted in step S20 in the storage 22 as a storage processing (step S22). When step S22 ends, or when it is determined that the driving operation is not the first operation (step S16: NO), the flowchart illustrated in FIG. 2 ends. When the flowchart is ended, it is determined whether or not the operation switch of the storage system 1 is turned off by the operation of the occupant, for example. If the operation switch is not turned off, the process returns to step S10 and the process is repeated.

### SUMMARY OF EMBODIMENTS

For example, in an ADAS using a camera, erroneous detection in camera recognition causes an operation that a user feels unnecessary, which leads to degradation in system performance and discomfort to the user. In order to investigate the cause of such an operation, action information of the ADAS when the user feels unnecessary and related information such as an image at that time are necessary. However, since the operation that the user feels unnecessary is normal as the system operation, the conventional device cannot determine the recording start timing.

In the storage system 1, action information is acquired from the driving assistance ECU 6, and information related to the vehicle 2 driving operation of the driver is acquired from the operation detection sensor 5. Then, it is determined whether the driving operation of the driver is a first operation for suppressing assistance by the driving assistance ECU 6. In response to determining that the driving operation is the first operation, action information and external information related to the ambient environment of the vehicle 2 are stored in association with each other. First operation is performed when the driving assistance ECU 6 assistance is not needed for the driver. Therefore, by storing information based on the first operation of the driver, the storage system 1 can store information of a scene in which assistance that is normal as a system operation, however, is unnecessary for the driver is executed. Thus, the storage system 1 can appropriately store information related to the assistance control.

Since the storage device 20 includes not only the storage 22 but also the buffer 21 capable of temporary storage, the storage system 1 can store information of a scene in which assistance unnecessary for the driver is executed even when the reaction of the driving operation of the driver is delayed with respect to assistance unnecessary for the driver.

### Modification

While exemplary embodiments have been described above, various omissions, substitutions, and changes may be made without being limited to the exemplary embodiments described above.

For example, the action determination unit 13 may detect a driving operation in a direction opposite to a steering direction in the driving assistance ECU 6 based on a detection result of a yaw rate sensor (the internal sensor 4) instead of a detection result of a steering angle sensor (the operation detection sensor 5). The information associated with the action information may include not only external information but also map information, GPS own vehicle position information, or the like.

The driving assistance ECU 6 may assist in notifying the driver of the target speed as the ADAS. For example, a speed limit (an example of a target speed) obtained from a sign by image recognition may be displayed on a display panel in the vehicle cabin. Then, the action determination unit 13 determines whether the driving operation is a second operation in which the vehicle travels at a speed that deviates from the speed limit notified to the driver by a threshold value speed or more. The threshold value speed is preset to determine whether the driving operation is a second operation. In response to determining that the driving operation is the second operation, the storage unit 14 may store the action information and the external information in the storage device in association with each other.

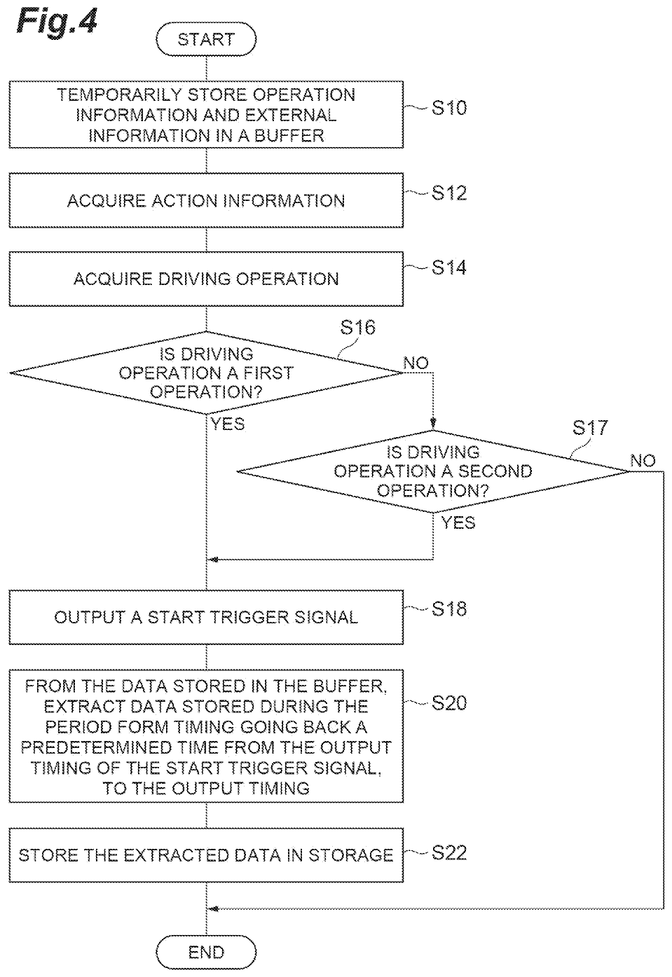

FIG. 4 is a flowchart illustrating another example of the operation of the storage system according to one embodiment. The flowchart shown in FIG. 4 is the same as the flowchart shown in FIG. 3 except that step S17 is added. Only the differences will be described below, and redundant description will not be repeated.

When it is determined that the driving operation is not the first operation (step S16: NO), it is determined whether the driving operation is the second operation based on the action information (displayed speed information) acquired in step S12 and the current vehicle speed, assuming that the action determination unit 13 of the storage control ECU 10 is a second determination processing (step S17). For example, if the displayed speed is 100 km/h and the current speed is 40 km/h, then it is likely that the displayed speed is a misrecognized speed and is ignored by the driver. If the threshold value speed is set to 30 km/h, the driving operation running at 40 km/h is determined to be the second operation.

When it is determined that the driving operation is the second operation (step S17: YES), the storage unit 14 outputs a start trigger signal to the storage device 20 as the instruction processing (step S18. When it is determined that the driving operation is not the second operation (step S17: NO), the flowchart illustrated in FIG. 4 ends. By executing the flowchart shown in FIG. 4, the storage system 1 can more appropriately store information related to assistance control.

### REFERENCE SIGNS LIST

1 . . . storage system, 2 . . . vehicle, 3 . . . external sensor, 4 . . . internal sensor, 5 . . . operation detection sensor, 6 . . . driving assistance ECU, 9 . . . drive recorder, 10 . . . storage control ECU, 11 . . . assistance content acquisition unit (an example of a first acquisition unit), 12 . . . operation acquisition unit (an example of a second acquisition unit), 13 . . . action determination unit (an example of a determination unit), 14 . . . storage unit, 20 . . . storage device, 21 . . . buffer, 22 . . . storage.

What is claimed is:

1. A storage system for storing action information of an assistance system that assists a driver of a vehicle, the storage system comprising:
a storage device;
a first acquisition unit configured to acquire action information from the assistance system;
a second acquisition unit configured to acquire information related to a driving operation of the vehicle of the driver;
a determination unit configured to determine whether the driving operation is a first operation in which assistance by the assistance system is suppressed, based on the action information acquired by the first acquisition unit and information related to the driving operation acquired by the second acquisition unit; and
a storage unit configured to store the action information and external information related to an ambient environment of the vehicle in the storage device in association with each other in response to the determination unit determining that the driving operation is the first operation.

2. The storage system according to claim 1, wherein the storage device includes a first storage device and a second storage device, and
the first storage device temporarily stores the action information and the external information in association with each other, and
the second storage device acquires and stores information from the first storage device, and
in response to the determination unit determining that the driving operation is the first operation, the storage unit outputs an instruction to the second storage device to acquire and store the action information and the external information stored in a period from start timing to operation timing at which the first operation is executed, the start timing being time going back by a predetermined time from the operation timing, among the action information and the external information stored in the first storage device.

3. The storage system according to claim 1, wherein the first operation is at least one driving operation of an operation of changing an irradiation position of a headlight set by the assistance system, a steering operation in a reverse direction during steering assistance by the assistance system, a brake operation during acceleration assistance by the assistance system, and an accelerator operation during deceleration assistance by the assistance system.

4. The storage system according to claim 1,
wherein the assistance system provides assistance for notifying the driver of a target speed, and
the determination unit further determines whether the driving operation is a second operation in which the vehicle travels at a speed that deviates from the target speed notified to the driver by a threshold value speed or more, and
the storage unit associates the action information to store the action information and the external information in association with each other in response to the determination unit determining that the driving operation is the second operation.

5. A storage control device for storing action information of an assistance system that assists a driver of a vehicle in a storage device, the storage control device comprising:
a first acquisition unit configured to acquire action information from the assistance system;
a second acquisition unit configured to acquire information related to a driving operation of the vehicle of the driver;
a determination unit configured to determine whether the driving operation is a first operation in which assistance by the assistance system is suppressed, based on the action information acquired by the first acquisition unit and information related to the driving operation acquired by the second acquisition unit; and
a storage unit configured to store the action information and external information related to an ambient environment of the vehicle in the storage device in association with each other in response to the determination unit determining that the driving operation is the first operation.
